(19) United States
(12) Patent Application Publication
(10) Pub. No.: US 2026/0029321 A1
(43) Pub. Date: Jan. 29, 2026

(54) METHOD FOR DETERMINING A PROPERTY OF A BULK MATERIAL

(71) Applicant: Qlar Europe GmbH, Darmstadt (DE)

(72) Inventors: Viktor RAIS, Darmstadt (DE); Herman DE JONG, Darmstadt (DE)

(73) Assignee: Qlar Europe GmbH, Darmstadt (DE)

(21) Appl. No.: 19/343,386

(22) Filed: Sep. 29, 2025

Related U.S. Application Data
(63) Continuation of application No. PCT/EP2024/058020, filed on Mar. 26, 2024.

(30) Foreign Application Priority Data
Mar. 27, 2023 (DE) 10 2023 107 570.5

(51) Int. Cl. G01N 15/0227; G01N 15/00; G01N 15/02

(52) U.S. Cl. CPC G01N 15/0227; G01N 2015/0096; G01N 2015/0294

(57) ABSTRACT

A method for determining at least one specific piece of information relating to a bulk material. A method for generating a data record including at least one piece of information relating to a bulk material, a method for obtaining a piece of information relating to a bulk material and a database, and devices and computer-implemented data structures are also provided.

This nonprovisional application is a continuation of International Application No. PCT/EP2024/058020, which was filed on Mar. 26, 2024, and which claims priority to German Patent Application No. 10 2023 107 570.5, which was filed in Germany on Mar. 27, 2023, and which are both herein incorporated by reference.

### FIELD OF THE INVENTION

The present invention relates to a method for determining at least one specific piece of information relating to a bulk material. The invention further relates to a method for generating a data record including at least one piece of information relating to a bulk material, a method for obtaining a piece of information relating to a bulk material and a database, devices, a computer program product, a signal sequence and computer-implemented data structures.

### DESCRIPTION OF THE BACKGROUND ART

Dosing devices for dosing bulk material consist of a plurality of components that must be suitably selected and coordinated with one another depending on the bulk material to be dosed. To design a dosing device, up to now it was often necessary to examine the physical properties of the bulk material to be dosed in the laboratory and to test its interaction with different designs of the mechanical components and with different settings of the operating parameters in trial arrangements. However, reproducible and therefore reliable results from such investigations are only possible with time-consuming and cost-intensive measures that also require the use of specially trained personnel.

### SUMMARY OF THE INVENTION

It is therefore an object of the present invention to overcome the described disadvantages of the prior art and in particular to provide means with which, against the background of a bulk material to be dosed, information on the bulk material can be determined in a simple yet reliable manner, so that the use of the bulk material in a dosing device can be reliably planned and prepared.

In an example, a method is provided for determining specific information about a bulk material is proposed; the method comprising obtaining a first image capture of a sample of the bulk material, determining a first piece of bulk material information based on the data of the first image by means of a first evaluation module, and/or obtaining a second piece of bulk material information by means of a user input, in particular via a human-machine interface, wherein the second piece of bulk material information is a haptic property of the bulk material. Based on the data from the first and second bulk material information, the specific information about the bulk material is then determined using a processing module.

The invention is therefore based on the surprising finding that, based on an image capture of a bulk material to be dosed, one or more pieces of information about the bulk material, which in particular relate to properties of the bulk material, can be at least implicitly derived, with which a dosing behavior of the bulk material can be assessed. Supported by additional user input regarding further bulk material information, complex investigations of the bulk material with regard to its physical properties can thus be eliminated or at least reduced.

The information obtained using the method thus provides a solid basis for making further preparations for the use of the bulk material not only more quickly than before, but above all also reliably. For example, in this context, a suitable dosing device can be selected with the help of the information obtained. This may include selecting components and/or operating parameters.

Surprisingly, it has been shown that the method can provide information about the bulk material as well as about previously known bulk materials. But also relevant information for bulk materials that are being used for the first time, for example in a production environment, can be advantageously determined.

In this context, it has been particularly surprisingly shown that the information obtained with the proposed method can sometimes even be superior to the data obtained by an expert in the laboratory. Thus, the bulk material can apparently sometimes be described even better with the information obtained from the images than with conventional parameters, which up to now have been determined by complex sample tests on complicated test rigs, for example for physical parameters of the bulk material.

In this respect, the method is also particularly advantageous in that it allows operating an existing dosing device alternately with different bulk materials without great effort. This is because no material-specific background knowledge is necessary to obtain information about the respective bulk material. This can increase the utilization of the dosing device and thus its cost-effectiveness as well as the operational reliability.

The invention is therefore based on the surprising finding that, based on an image capture of a bulk material to be dosed, one or more pieces of information about the bulk material, which in particular relate to properties of the bulk material, can be at least implicitly derived, with which a dosing behavior of the bulk material can be assessed. Supported by additional user input regarding further bulk material information, complex investigations of the bulk material with regard to its physical properties can thus be eliminated or at least reduced.

The information obtained using the method thus provides a solid basis for making further preparations for the use of the bulk material not only more quickly than before, but above all also reliably. For example, in this context, a suitable dosing device can be selected with the help of the information obtained. This may include selecting components and/or operating parameters.

Surprisingly, it has been shown that the method can provide information about the bulk material as well as about previously known bulk materials. But also relevant information for bulk materials that are being used for the first time, for example in a production environment, can be advantageously determined.

In this context, it has been particularly surprisingly shown that the information obtained with the proposed method can sometimes even be superior to the data obtained by an expert in the laboratory. Thus, the bulk material can apparently sometimes be described even better with the information obtained from the images than with conventional parameters, which up to now have been determined by complex sample tests on complicated test rigs, for example for physical parameters of the bulk material.

In this respect, the method is also particularly advantageous in that it allows operating an existing dosing device alternately with different bulk materials without great effort. This is because no material-specific background knowledge is necessary to obtain information about the respective bulk material. This can increase the utilization of the dosing device and thus its cost-effectiveness as well as the operational reliability.

Above all, the proposed method makes it possible even for a technical layperson to determine reliable information about a bulk material to be dosed in order to then, for example, select components of a dosing device based on this information and/or replace components of an existing dosing device as well as to adjust the operating parameters of the dosing device accordingly.

Examples of advantageous bulk materials are rock, building materials, in particular topsoil, sand, gravel and/or cement, raw materials, in particular ore, coal, clay and/or road salt, foodstuffs, in particular grain, sugar, salt, coffee and/or flour, and/or powdered goods, in particular pigments, fillers, granules and/or pellets.

The type of bulk material can be, for example, one of the following bulk material types: Dust, powder, flour, grains, granules, grist, lumps, pellets and/or other materials.

The method can be advantageously computer-implemented.

The process can advantageously be provided as a cloud service. This means that no extensive data processing needs to take place at the location of the bulk material for which the information is to be determined.

The method can comprise storing the at least one specific piece of information as a data record in a database, in particular in a material database for bulk material.

Obtaining an image capture advantageously comprises obtaining data, in particular image data, of the image capture. For example, the data represents pixel values of the image capture. This data can be received in raw format, in a pre-processed image format and/or from a suitable light-sensitive sensor.

If, in the present application, information is determined “based on” certain data, this should advantageously can be understood to mean that without these certain data the information could not be determined. Therein, these certain data (which can be referred to as source data) can be subjected to one or more data processing steps in order to obtain processed data. Within these data processing steps, certain data can be evaluated, further processed and/or merged with other data. With the help of said certain data, further information, in particular from further sources, such as databases, can be obtained and presented as intermediate results. Within data processing steps, the additional information may be subjected to further data processing steps in addition to or instead of the certain data and/or processed data, including processing with other certain data. The latter means, in more general terms, that several different data sets can be present, “based on” which the information is determined, wherein these can each be processed individually and at a specific processing step two or more different such initial data sets, if necessary, each already in processed form, are merged and optionally used as input data for subsequent data processing.

It can also be provided that the method comprises the at least one specific piece of information being determined by means of a processing module, the data of the first image capture being included in the determination of the specific information by means of the processing module and/or a first piece of information about the bulk material being determined based on the data of the first image capture by means of a first evaluation module, and wherein the first piece of bulk material information is included in the determination of the at least one specific piece of information by means of the processing module and/or the first piece of information is the at least one specific piece of information.

Preferably, several first pieces bulk material information can be determined and optionally included in the determination of the specific information. In one embodiment, the (at least one) first piece of bulk material information is determined using image processing and evaluation methods based on the first image capture. For example, these are machine learning methods. Preferably, the first piece of bulk material information is determined by means of the first evaluation module and/or the first piece of bulk material information (along with optional further data) is used by the processing module to determine the specific piece of information.

The first piece of bulk material information can be, for example, a first bulk material property, such as a material property of the bulk material.

The processing module can be implemented, for example, in software, in hardware or a combination of both. The processing module may alternatively or additionally comprise a memory, a processor, a receiving device (for example, to receive the image capture), a transmitting device (for example, to send a generated signal to another entity) or any combination thereof. Alternatively or additionally, the processing module can provide and/or make available and/or comprise everything that is comprised by it, in particular all the resources necessary for this purpose, for example in the form of software and/or hardware resources.

The first evaluation module can be implemented, for example, in software, in hardware or a combination of both. The first evaluation module may alternatively or additionally comprise a memory, a processor, a receiving device (for example, to receive the image capture), a transmitting device (for example, to send a generated signal to another entity) or any combination thereof. Alternatively or additionally, the first processing module can provide and/or make available and/or comprise everything that is comprised by it, in particular all the resources necessary for this purpose, for example in the form of software and/or hardware resources.

The processing module can comprise the first evaluation module. The first evaluation module and the processing module can preferably also be identical and thus a common module.

The two modules can be operated spatially separated from each other. This is advantageous when the two modules have different requirements for hardware and/or software resources and thus the module with more computationally intensive operations can be operated in an environment with sufficient hardware and/or software resources. In this case, the modules can exchange data with each other, for example via a data connection.

At least the data of the first image capture can represent input data and/or at least the first piece of bulk material information represents output data of the first evaluation module. Further input and/or output data, in particular those described elsewhere in the application, are possible.

At least the data of the first image captures and/or at least parts of the output data of the first evaluation module can represent input data and/or at least the determined specific piece of information represents output data of the processing module in each case. Further input and/or output data, in particular those described elsewhere in the application, are possible.

Preferably, the output data of a module can be obtained by the respective module at least in part by processing at least the input data of the respective module, i.e. evaluating, analyzing and/or converting them into new data.

It can also be provided that the method comprises obtaining at least a second image capture of the sample of the bulk material, and wherein (i) the specific piece of information about the bulk material is determined on the basis of the data of the first and second image capture by means of the processing module and/or (ii) the data of the second image capture are included in the determination of the specific piece of information by means of the processing module, wherein preferably (i) the first piece of information about the bulk material is determined on the basis of the data of the first and second image capture by means of the first evaluation module, and/or (ii) a second piece of information about the bulk material is determined on the basis of the data of the first and/or second image capture by means of a second evaluation module and is included in the determination of the at least one specific piece of information partly by means of the processing module.

The data from the second image capture can be used in addition to the data from the first image capture to determine the specific piece of information.

The data from the first image capture may not be used to determine the second piece of information. For example, the second piece of information can then be determined based on the data of the second image capture in such a way that at least the data of the second image capture but not the data of the first image capture is fed to the data input of the respective evaluation module. Preferably, further input data can be provided, wherein that is not the data of the first image capture.

It is also advantageously possible to determine the first piece of bulk material information and/or the second piece of bulk material information using the data from the first and second image capture. For this purpose, the data from the first and second image capture can advantageously be fed to the data input of the respective evaluation module. Preferably, further input data can be provided.

The second evaluation module can be implemented in software, hardware or a combination of both. The second evaluation module may alternatively or additionally comprise a memory, a processor, a receiving device (for example, to receive the image capture), a transmitting device (for example, to send a generated signal to another entity) or any combination thereof. The second evaluation module can alternatively or additionally provide and/or make available and/or comprise everything that is comprised by it, such as in particular all the resources necessary for this purpose, for example in the form of software and/or hardware resources.

The processing module can comprise the second evaluation module. The second evaluation module and the processing module can preferably also be identical and thus a common module.

The two modules can be operated spatially separated from each other. This is advantageous when the two modules have different requirements for hardware and/or software resources and thus the module with more computationally intensive operations can be operated in an environment with sufficient hardware and/or software resources. In this case, the modules can exchange data with each other, for example via a data connection.

It is also possible that the first evaluation module, the second evaluation module and the processing module can be identical and/or that the first evaluation module and the second evaluation module can be identical.

At least the data of the second image capture may represent input data of the first evaluation module. Further input and/or output data, in particular those described elsewhere in the application, are possible.

The data of the first and/or second image captures can represent input data and/or the second piece of information represents output data of the second evaluation module. Further input and/or output data, in particular those described elsewhere in the application, are possible.

The data of the second capturing and/or the second information can represent input data of the processing module. Further input and/or output data, in particular those described elsewhere in the application, are possible. In this manner, the processing module can advantageously determine the specific information while taking into account the respective data.

The method can comprise evaluating and/or analyzing the data of the first and/or second image capture using methods of digital image analysis, in particular at least partially in the field of machine learning, in particular in order to determine the first piece of information, the second piece of information and/or the at least one specific piece of information.

Advantageously, digital image analysis is carried out using machine learning methods. For this purpose, a machine learning model can be trained on training data that is of the type of input data expected later, each with assigned expected output data, and the trained model can be used to calculate output data that represents the respective specific piece of information or other piece of information based on the respective input data.

Therefore, for example, the processing module can execute corresponding methods, in particular on at least the data of the first and/or second image capture and/or the first and/or second piece of information on the bulk material, in order to at least partially determine the specific piece of information.

Therefore, for example, the first evaluation module can execute corresponding methods, in particular on at least the data of the first and/or second image capture, in order to at least partially determine the first piece of information of the bulk material.

Therefore, for example, the second evaluation module can carry out corresponding methods, in particular on at least the data of the first and/or second image capture, in order to at least partially determine the second piece of information of the bulk material.

The determination of the at least one specific information item can comprise the determination of a classification, in particular with regard to the type of bulk material, a, preferably average, particle size of the bulk material and/or a particle shape, and/or an identifier of the bulk material in each case, and wherein preferably a result of the classification and/or the identifier is the specific piece of information.

A classification can, for example, refer to the type of bulk material. Within the framework of the classification, the bulk material can therefore be classified into at least one of the following classes of types: Dust, powder, flour, grains, granules, grist, lumps, pellets and/or other materials. Alternatively or additionally, a classification may also refer to a particle size, in particular the average size, of the bulk material. Thus, the classification can advantageously have the bulk material type and/or a particle size as a result.

The identifier can, for example, be a unique identifier (e.g. an alphanumeric character string) of the bulk material. Advantageously, further information, which is, for example, pre-stored, can be determined for the bulk material represented by the identifier, in particular by including a database. Then, for example, information such as material specifications of the bulk material can be retrieved from a database based on the identifier for the bulk material. This will be discussed in more detail below.

The method can comprise that, at least partially based on the classification and/or the identifier, information, in particular comprising a first piece of bulk material information, can be retrieved from a database about a bulk material assigned to the classification and/or the identifier and is included in the determination of the at least one specific piece of information, in particular at least partially by means of the processing module, and/or is used as the specific information.

The additional information allows the specific information to be determined even more reliably and securely. In this manner, information about the bulk material can also be taken into account that cannot be directly extracted from the capturing data, but which can be obtained from other sources (such as the database). For this purpose, the identifier can be used as a connecting link (relation). Thereby the specific information is obtained based on the data from the image capture and with the further use of other resources (such as databases, etc.).

The retrieved information may, for example, be or comprise information about the bulk material, such as a first piece of bulk material information of the bulk material.

The information can be advantageously obtained based on the identifier, i.e. retrieved from the database.

Thus, in an example, additional information about the bulk material (in particular based on the identifier from a database) can be determined and included in the determination of the specific information (in particular at least partially by means of the processing module).

Preferably, the information concerns material properties of the bulk material. Based on the material properties, specific information can advantageously be assessed, for example, regarding the suitability of the bulk material for use in a specific type of dosing device, a dosing device with specific equipment, for example with regard to mechanical components and/or the setting of operating parameters. Therefore, it is advantageous if, starting from the data of the first image capture and with the help of the identifier, one or more material properties are obtained and included in the determination of the specific piece of information.

The retrieved information can advantageously be supplied to an entity and/or provided to a user, for example on a user interface such as a screen. Through this, besides the specific piece of information, this additional piece of information can also be provided.

At least the retrieved pieces of information can represent input data of the processing module. Further input and/or output data, in particular those described elsewhere in the application, are possible.

The method can comprise obtaining at least one volume of data, which volume of data represents at least one second piece of information about the bulk material, preferably implicitly or explicitly, wherein (i) at least partly based on the obtained volume of data, the at least one specific piece of information is determined, in particular at least partly by means of the processing module, and/or (ii) the obtained volume of data is included in the determination of the at least one specific piece of information, in particular at least partly by means of the processing module.

The obtained volume of data can therefore be used in addition to at least the data from the first and/or second image capture to determine the specific piece of information. The data of the first and/or second image capture and the data volume can, for example, be processed together (e.g. as input data for the first evaluation module) in order to obtain at least one common intermediate value, which in turn is further processed (e.g. as input data of the processing module) in order to determine the specific piece of information. Or at least a first intermediate value is obtained from the image data and at least a second intermediate value is obtained from the volume of data, and the first and second intermediate values are further processed (i.e. by means of the processing module) in order to determine the specific information.

The volume of data can, for example, represent and/or encode one or more pieces of information about the bulk material. Alternatively or additionally, the volume of data could also represent a, preferably binary, character sequence, with each position representing a piece of information about the bulk material. An example of such a character sequence is the binary sequence 0101011101, wherein in this sequence the presence (“1”) or the absence (“0”) of the respective property for the bulk material is coded for ten bulk material properties (for example “sticky”, “electrostatic”, “granular”, . . . ).

The obtained volume of data can therefore be used in addition to at least the data from the first and/or second image capture to determine the specific information.

The information represented through the obtained volume of data advantageously can represent a piece of information different from the first and/or second piece of information mentioned elsewhere.

At least the obtained volume of data can represent input data of the processing module. Further input and/or output data, in particular those described elsewhere in the application, are possible.

It may also be provided that the data volume can be obtained through user input, in particular via a human-machine interface.

It can also be provided that (i) the first image capture and the second image capture can be carried out, preferably simultaneously or temporally successively, from different perspectives and/or (ii) the bulk material sample is in a first sample configuration during the first image capture and the bulk material sample is in a second sample configuration during the second image capture, wherein the bulk material sample is preferably transferred from the first sample configuration to the second sample configuration between the two image captures.

For example, the first and second image captures can be captured with one and the same capturing device and the position and/or orientation of the capturing device can be changed between the image captures in order to capture the two image captures temporally successively from different perspectives.

For example, the first and second image captures may be captured with different capturing devices, wherein the capturing devices have different positions and/or orientations. Thus, the two image captures can particularly advantageously be captured simultaneously from different perspectives.

The perspectives of the two image captures can be identical.

A sample configuration can be understood to mean the type and manner of a spatial arrangement of the bulk material of the sample, in particular under existing boundary conditions, such as existing environmental conditions, and/or the conditions of the formation of material accumulations (e.g. clumps) within the arrangement.

For example, a bulk material sample can be piled up on a flat surface from a feed pipe from a certain height. The manner in which the bulk material sample forms a heap can then be understood as the sample configuration. This sample configuration may differ from another sample configuration which is obtained when the bulk sample is piled onto the flat base from a different height. Instead of the height, the angle of inclination of the base could also be changed.

The first and second sample configurations can be two differently formed heaps of the bulk material sample and/or at least one parameter of the ambient conditions, such as ambient temperature, air humidity and/or ambient pressure, of the bulk material sample is changed between the first and second sample configuration.

The bulk material in both sample configurations can be in a state of equilibrium with the respective existing physical environmental conditions.

For example, a heap can be formed with the sample at two different ambient temperatures (preferably using the same procedure in each case). The different formation of the heap in the two cases represents the different sample configurations. The bulk material of the sample is always at the respective ambient temperature, i.e. in an equilibrium state.

Another possible environmental condition is the inclination of the base (also mentioned above) on which the bulk material sample is piled up.

It can also be provided that a control signal representing the specific information determined can be generated and preferably fed to an entity and/or output to a user on a human-machine interface, such as a screen and/or wherein a dosing device is influenced, configured and/or controlled at least partially based on the determined specific piece of information.

The control signal advantageously makes it possible to provide an entity with the specific piece of information. For example, the entity may be a higher-level dosing device monitoring system and/or a dosing device management system. Alternatively or additionally, the control signal can be sent to the entity to initiate monitoring of the dosing device and/or for documentation purposes. In this manner, current information on the respective bulk material can advantageously be obtained continuously even during ongoing operation of the dosing device.

The entity can be the dosing device with which the bulk material is dosed or is to be dosed, or parts thereof, such as a motor or its motor control. The entity may, for example, also be a device different from the dosing device.

The control signal may be an analog or a digital signal. Alternatively or additionally, the control signal can also be a command within a software application.

It can also be provided that at least one reference object can be at least partially recognizable in the first image capture and/or the second image capture, and wherein the reference object preferably has defined dimensions and/or patterns and/or is used to determine a distance, in particular a particle size of the bulk material, in the first and/or second image capture.

The reference object can be advantageously used for determining dimensions of structures contained in the first and/or second image capture if the dimensions of the reference object are known.

The reference object can be a base or parts thereof on which bulk material can be piled up. For example, the reference object has a pattern, such as a checkerboard pattern. This is advantageous because a reference length is obtained using the reference object even if areas of the reference object are obscured (e.g. by the bulk material).

The reference object may, for example, have a rectangular main side and preferably be a planar and/or plate-shaped element. Such a reference object can be placed or positioned appropriately next to the bulk material sample during the image capture.

The reference object can also advantageously provide a piece of information for an ML model, discussed in detail below, which ML model is used to evaluate the first and/or second image capture. In this case, the ML model can, for example, learn a relationship between the reference object and a particle size of the bulk material. Therefore, the reference object can advantageously also be included in the images used to train the ML model.

It can also be provided that the first image capture can be an image capture, preferably in the visible, infrared or ultraviolet spectral range, retrieved from a memory, received from a sensor, in particular an optical sensor, and/or received via a data connection.

The first image capture can advantageously be captured with a camera. Said camera can, for example, have a sensor that is sensitive in the visible, infrared and/or ultraviolet spectral range. By choosing the sensor type, i.e. which spectral components of the light are recorded for the image capture, different features can advantageously be determined directly based on the data of the first image capture.

For example, an infrared camera can be used to determine the temperature of the bulk material and the specific information of this bulk material can be determined based at least partly on the temperature.

Furthermore, the first image capture can also be taken using a radar sensor and/or an X-ray device.

The first image capture of the bulk material to be dosed can be taken, for example, before the dosing device is filled with the bulk material to be dosed. For example, the bulk material captured by the first image capture may be in a, preferably sealed, material packaging. For example, the bulk material captured by the first image capture can be located in the inlet of the dosing device and/or in a storage container from which the bulk material is advantageously extracted and fed to the dosing device. In one embodiment, the bulk material captured by the first image capture is located outside the dosing device, inside the dosing device and/or in front of and/or behind the discharge member.

It can also be provided that the second image capture can be an image capture, preferably in the visible, infrared or ultraviolet spectral range, retrieved from a memory, received from a sensor, in particular an optical sensor, and/or received via a data connection.

The second image capture can advantageously be captured with a camera. Said camera can, for example, have a sensor that is sensitive in the visible, infrared and/or ultraviolet spectral range. By choosing the sensor type, i.e. which spectral components of the light are captured for the image, different features can advantageously be determined directly based on the data of the second image capture.

For example, an infrared camera can be used to determine the temperature of the bulk material and the specific information of this bulk material can be determined based at least partly on the temperature.

Furthermore, the second image capture can also be captured using a radar sensor and/or an X-ray device.

The second image capture of the bulk material to be dosed can be captured, for example, before the dosing device is filled with the bulk material to be dosed. For example, the bulk material captured by the second image capture can be in a, preferably sealed, material packaging. For example, the bulk material captured by the second image capture can be located in the inlet of the dosing device and/or in a storage container from which the bulk material is advantageously extracted and fed to the dosing device. In one embodiment, the bulk material captured by the second image capture is located outside the dosing device, inside the dosing device and/or in front of and/or behind the discharge member.

The processing module can have an ML model that has been pre-trained and/or is included in the determination of the specific piece of information.

Advantageously, the machine learning model (ML model) can be trained with data from a plurality of image captures of one or more known bulk materials. In this manner, it is possible to learn a relationship between an image capture (of a bulk material) on the one hand, and a specific bulk material or information about it (such as an identifier and/or information about the bulk material) on the other hand, and/or a specific piece of information about the bulk material. Alternatively or additionally, besides the capturing data, further or other information such as a first and/or second piece of bulk material information can be provided as input data and the training can take this information into account accordingly. This allows the learned relationship to be expanded or changed.

The ML model preferably comprises, at least in part, the input data and output data of the processing module as input data and output data. The ML model therefore advantageously calculates the output data based on the input data. Accordingly, the ML model is advantageously trained on input data that corresponds to the input data used later.

The ML model can also have learned a relationship between identifiers (of bulk material) on the one hand and specific pieces of information on the other. Optionally, additional information can be provided as input data and the training can take this information into account accordingly. This allows the learned context to be expanded.

Convolutional neural networks (CNN), especially from the field of deep learning, have proven to be advantageous for extracting information from images, and are therefore preferably used as the basis for the first ML model.

The first ML model can also be retrained with subsequent, newly recorded image captures. This allows the reliability and quality of the obtained specific piece of information to be continuously improved.

It can also be provided that the first evaluation module can have an ML model that has been pre-trained and/or is included in the determination of the first and/or second piece of bulk material information and/or the identifier.

The second evaluation module can have an ML model that has been pre-trained and/or is included in the determination of the second piece of bulk material information.

Advantageously, the machine learning model (ML model) of the first and/or second evaluation module can be trained with data from a large number of image captures of one or more known bulk materials. In this manner, it is possible to learn a relationship between an image capture (of a bulk material) on the one hand, and a specific bulk material or information about it (such as an identifier or a piece of information about the bulk material) on the other hand. Optionally, the relationship with different sample configurations can also be learned.

Advantageously, an ML model can be used in both the processing module and the first and second evaluation modules, wherein the ML models are independent. In this case, it is advantageous if the ML model of the processing module is at least partially trained with data that results from the output of the ML model of the first and/or second evaluation module and/or that is determined based at least partially on the output data of the ML model of the first and/or second evaluation module. In this manner, the ML model of the processing module can learn a relationship between the respective output data of the first and/or second evaluation module (as well as any additional pieces of information) on the one hand, and a specific piece of information on the other hand.

If the ML models is present, specific information can therefore advantageously be determined with the ML model of the processing module, at least partially based on the output data of the ML model of the first and/or second evaluation module and/or the information determined on the basis of the output data of the ML model of the first and/or second evaluation module.

Convolutional neural networks (CNNs), particularly from the field of deep learning, have proven to be advantageous for extracting information from images, and are therefore preferably used as the basis for the ML model of the first and/or second evaluation module.

The ML model of the first and/or second evaluation module can also be retrained with newly recorded image captures. This allows the reliability and quality of the obtained specific piece of information to be continuously improved.

The ML model of the respective evaluation module can comprise, at least partially, the input data and output data of the respective evaluation module as input data and output data. The respective ML model therefore advantageously calculates the output data based on the input data. Accordingly, the ML model is advantageously trained on input data that corresponds to the input data used later.

It can also be provided that the first piece of bulk material information can be at least one of the following properties of the bulk material or a measure thereof: A grain shape, a grain size, a particle size, an angle of repose, an angle of discharge, a physical property, a chemical property, a moisture content, a material type, a density, a flow behavior, a tendency to bridge, a tendency to shoot when fluidized, a clumping content, an electrostatic chargeability, a chemical instability, a temperature sensitivity, suspended in air, a tendency to segregate, consisting of components, a free flowability, a tendency to agglomerate, an abrasiveness, a corrosiveness, a mechanical sensitivity, a fragility, an explosiveness, a flammability, a dustiness, a moisture, an adhesion, a consistency, a hygroscopic behavior, a temperature, a tendency to fluidize, a tendency to harden, a radioactivity, a toxicity, a thixotropic behavior, a tendency to spoil, a tendency to soften, a static electricity, a presence of oils and fats, a flakiness and/or a stickiness.

It can also be provided that the second bulk material information can be or characterizes a haptic property of the bulk material or is at least one of the following properties of the bulk material or a measure thereof: A grain shape, a grain size, a particle size, an angle of repose, an angle of discharge, a physical property, a chemical property, a moisture content, a material type, a density, a flow behavior, a tendency to bridge, a tendency to shoot when fluidized, a clumping content, an electrostatic chargeability, a chemical instability, a temperature sensitivity, suspended in air, a tendency to segregate, consisting of components, a free flowability, a tendency to agglomerate, an abrasiveness, a corrosiveness, a mechanical sensitivity, a fragility, an explosiveness, a flammability, a dustiness, a moisture, an adhesion, a consistency, a hygroscopic behavior, a temperature, a tendency to fluidize, a tendency to harden, a radioactivity, a toxicity, a thixotropic behavior, a tendency to spoil, a tendency to soften, a static electricity, a presence of oils and fats, a flakiness and/or a stickiness.

Further information on bulk solids properties (in particular on material properties of bulk solids) can be found, for example, in the document “Allgemeine Schüttguteigenschaften und ihre Darstellung in Kurzform” of the “FEDERATION EUROPEENNE DE LA MANUTENTION SECTION II”, FEM 2 582, Original D, Edition D, November 1991, the document “Spezifische Schüttguteigenschaften bei der mechanischen Förderung” of the “FEDERATION EUROPEENNE DE LA MANUTENTION SECTION II”, FEM 2 181, Original E, Edition D, 1989, and the document “Schüttguteigenschaften” of the “FEDERATION EUROPEENNE DE LA MANUTENTION SECTION II”, FEM 2 581, Original D, Edition D, November 1991.

The object is also achieved in an example, according to a second aspect by proposing a method for generating a data record with at least one piece of information about a bulk material, in particular with regard to at least one property of the bulk material, the method comprising offering a screen output on a user interface to a user, determining an interaction of the user with the screen output on the user interface in response to the offering of the screen output, and generating, based on the determined interaction of the user, at least one characteristic value that can be stored in a database for the at least one piece of information about the bulk material, in particular the at least one property of the bulk material, as a data record.

The invention is therefore based on the surprising finding that the manual recording of measured values or the like and the carrying out of complex physical examinations on bulk material samples prior to this procedure is unnecessary if the information on the bulk material, such as in particular bulk material properties, is queried with the aid of screen interactions that are easy to carry out by a user.

This eliminates the need for complex material tests in the laboratory (e.g. in the form of a shear test, etc.) or at least reduces the scope. In addition, bulk material information can be easily determined and generated as a data record even by laypersons.

Such data sets can be used to advantageously create, build and/or supplement a knowledge database on the material properties of bulk materials. In one embodiment, the data sets are therefore stored in a knowledge database on bulk materials, in particular on material properties of bulk materials.

For example, the procedure can be carried out using a smartphone. This enables mobile generation of data sets.

Preferably, the method can be computer-implemented.

It can also be provided that the user's interaction can be a swipe gesture on the user interface, which is designed in particular as a touch-sensitive screen, and/or a selection of at least one option from a selection menu offered on the screen output.

For example, with respect to a particular bulk property, a swipe gesture on the user interface in a first direction can be a first value of the bulk property and/or a swipe gesture on the user interface in a second direction can be a second value of the bulk property. For example, the bulk property can be stickiness and the first value can be “sticky” and the second value may be “non-sticky”.

The possible directions of a swipe gesture can be indicated to the user by at least temporarily displaying a help symbol. This makes operation safer for the user and supports the correct generation of the data record.

It can also be provided that a plurality of screen outputs can be offered to the user on the user interface, in particular in temporal succession, and for each screen output, an interaction of the user with the screen output on the user interface is determined in response to the offering of the respective screen output and, based on the determined interactions of the user, one or more than one characteristic value storable in a database for two or more than two pieces of information about the bulk material, in particular for two or more than two properties of the bulk material, is generated as a data record.

This makes it easy to carry out more extensive characterizations of the bulk material.

It can also be provided that a specific piece of information can be a haptic property of the bulk material or a measure thereof.

For example, at least one data record can be created for each of several bulk materials. A plurality of users can each generate a data record with at least one piece of information relating to at least one piece of information about a bulk material.

It can also be provided that several such data records can be generated, in particular through interactions of several users, and wherein preferably the several data records are transferred into a common data record in which the information on the bulk material is constructed from the information of the individual data records.

It is advantageous if several data records generated for one and the same bulk material (in particular if they were generated by more than one user) are replaced by a common data record, wherein the information from the several data records can be consolidated in the common data record, for example by averaging, in particular by means of a preferably user-dependent weighting of the individual data records.

It can also be provided that the data record or data records can be or are in each case associated with an assignment to the bulk material and/or stored in at least one database, in particular for the purpose of building, supplementing and/or updating a knowledge database on bulk material information.

The data record can also be the common data record.

This database can advantageously be the aforementioned knowledge database.

It can also be provided that the generated volume of data can be provided in a method according to the first aspect of the invention and is retained there as a volume of data, in particular representing a second piece of bulk material information.

It can also be provided that in a method according to the first aspect of the invention, the ML model of the first evaluation module, the second evaluation module and/or the processing module is at least partially trained with the generated data sets and/or the data stored in the database.

The object is also achieved in an example of the invention according to a third aspect by proposing a database designed to store data sets from a method according to the second aspect of the invention.

All advantages described with respect to the method according to the second aspect of the invention also apply accordingly to the database according to the third aspect of the invention. Therefore, in this place, reference can be made to the previous statements.

The object is achieved in an example of the invention according to a fourth aspect by proposing a method for obtaining information about a bulk material, comprising that at least a first image capture of at least one sample of the bulk material is captured, in particular in a first sample configuration and/or with a camera, and/or at least a second image capture of the sample of the bulk material is captured, in particular in a second sample configuration and/or with a camera, and is provided in a method according to the first aspect of the invention and is obtained there as a first image capture and/or second image capture.

In particular, the process by which the image captures are provided can also be carried out at a remote location, such as on a cloud computer. Thus, only a camera and a corresponding data connection must be provided on the client side in order to be able to use a method according to the fourth aspect of the invention.

For example, the procedure is carried out using a smartphone. This enables operators to obtain information about a bulk material on the move.

Preferably, the method can be computer-implemented.

All advantages described with respect to the method according to the first aspect of the invention also apply accordingly to the method according to the fourth aspect of the invention. Therefore, in this place, reference can be made to the previous statements.

Alternatively or additionally, it can also be provided that the method can comprise: (i) obtaining the specific information determined in the method according to the first aspect of the invention and/or obtaining the control signal generated in the method according to the first aspect of the invention, and/or (ii) determining and providing a property, in particular a material property, for example a haptic material property, of the bulk material, in particular manually, in the method according to the first aspect of the invention and obtaining it there as a volume of data representing a second bulk material information.

The object is achieved in an example of the invention according to a fifth aspect by proposing a data processing device, comprising means which are designed to carry out a method according to the first aspect of the invention and/or according to the second aspect of the invention.

The data processing device can comprise the processing module, the first evaluation module and/or the second evaluation module and/or be operatively connected thereto.

All advantages and options explained with respect to the method according to the first and/or second aspect of the invention also apply accordingly to a data processing device according to the fifth aspect of the invention. Therefore, reference can be made to the previous statements in this regard.

For example, the data processing device can be a cloud computer system. The data processing device can comprise or represent a distributed system.

The object can be achieved in an example of the invention according to a sixth aspect by proposing a dosing device which comprises a data processing device according to the fifth aspect of the invention and/or is operatively connected thereto.

Such a dosing device particularly advantageously enables continuously obtaining current bulk material information during operation of the dosing device and, for example, aborting an ongoing dosing process and/or not starting a new dosing process depending on the bulk material information.

All advantages and options explained with regard to the method according to the first and/or second aspect of the invention and with regard to the data processing device according to the fifth aspect of the invention also apply accordingly to a dosing device according to the sixth aspect of the invention. Therefore, reference can be made to the previous statements in this regard.

The object is achieved in an example of the invention according to a seventh aspect by proposing a data processing device, in particular a smartphone, with a camera and further means which are designed to provide images recorded with the camera in a method according to the first aspect of the invention in such a manner that these are obtained there as a first image capture and/or as a second image capture.

The smartphone may have a screen to display specific pieces of information. The data processing device can be used to carry out a method according to the second aspect of the invention.

The data processing device may optionally receive the specific information determined in the method according to the first aspect of the invention.

All advantages and options explained with respect to the method according to the second aspect of the invention also apply accordingly to the data processing device according to the seventh aspect of the invention. Therefore, reference can be made to the previous statements in this regard.

The object is also achieved in an example of the invention according to an eighth aspect by proposing a computer program product comprising instructions which, when the program is executed by a data processing device, in particular a device according to the fifth aspect of the invention, cause the device to carry out a method according to the first and/or second aspect of the invention.

The object is achieved in an example of the invention according to a ninth aspect by proposing a signal sequence representing instructions which, when executed on a data processing device, in particular a device according to the fifth aspect of the invention, cause the device to carry out a method according to the first and/or second aspect of the invention.

The object is achieved in an example of the invention according to a tenth aspect by proposing a computer-implemented data structure which has instructions in one area of the data structure for calculating a machine learning data model stored in another area of the data structure, so that the data model, when it is calculated according to the instructions by a data processing device on training data stored in a further area of the data structure, which in particular (i) have image recordings of bulk material samples each comprising an associated piece of bulk material information, (ii) have been at least partially obtained from a method according to the second aspect of the invention and/or (iii) have been at least partially retrieved from a database according to the third aspect of the invention, is trained in such a manner that by means of the trained data model at least one piece of information about the bulk material can be determined based on at least one image captures of at least one sample of a bulk material.

The data structure advantageously makes it possible to provide a bundle of a program product and a data model as well as training data as a single unit.

Preferably, the data structure is stored on a data storage medium.

The object is achieved in an example of the invention according to an eleventh aspect by proposing a computer-implemented data structure which has instructions in one area of the data structure for calculating a trained data model of machine learning stored in another area of the data structure, so that by means of the data model, when it is calculated at least on data of one or more image captures of at least one sample of a bulk material according to the instructions by a data processing device, at least one piece of information about the bulk material is determined, in particular by the trained data model analyzing the one or more image captures and carrying out a classification of the bulk material.

The data structure advantageously makes it possible to provide a bundle of a program product and a data model as a single unit.

Preferably, the data structure can be stored on a data storage medium.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

Further features and advantages of the invention will become apparent from the following description, in which preferred embodiments of the invention are explained with reference to schematic drawings.

FIG. 1 is a schematic depiction of a dosing device known from the prior art;

FIG. 2a is a first image capture of a sample of a bulk material in a first sample configuration;

FIG. 2b is a second image capture of the bulk material sample from FIG. 2a in a second sample configuration;

FIG. 3 is a flowchart of a method according to the first aspect of the invention in a first embodiment;

FIG. 4 is a flowchart of a method according to the first aspect of the invention in a second embodiment;

FIG. 5 is a flowchart of a method according to the first aspect of the invention in a third embodiment;

FIG. 6 is a flowchart of a method according to the second aspect of the invention;

FIG. 7 is a screen output;

FIG. 9 is a flowchart of a method according to the fourth aspect of the invention;

FIG. 10 is a schematic depiction of a data processing device according to the fifth aspect of the invention;

FIG. 11 is a schematic depiction of a dosing device according to the sixth aspect of the invention; and

FIG. 12 is a schematic depiction of a data processing device according to the seventh aspect of the invention.

### DETAILED DESCRIPTION

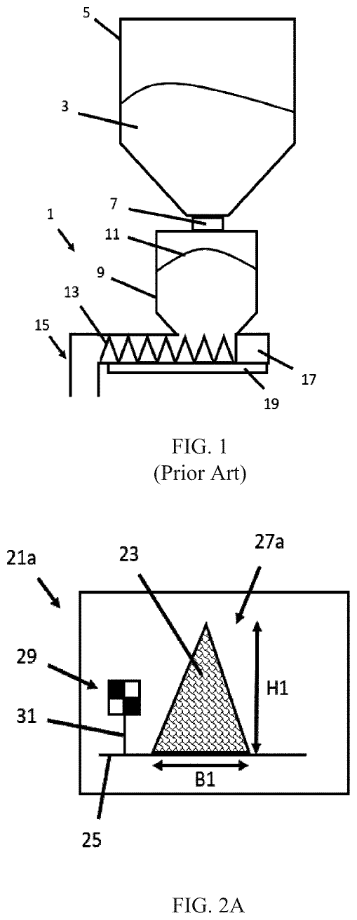

FIG. 1 shows a schematic depiction of a previously known dosing device 1.

The dosing device 1 is supplied with a bulk material 3 to be dosed from a storage container 5. From the storage container 5, the bulk material passes via a selectively openable and closable connecting section 7 into a receiving container 9 of the dosing device 1, in which it is present as a volume of bulk material with a surface 11. By opening the connecting section 7, bulk material can be transferred from the storage container 5 into the receiving container 9. By means of a discharge device 13, the bulk material 3 is then discharged in a per se known manner from the dosing device 1, i.e. from the receiving container 9, and leaves the latter via a vertical discharge outlet 15. The discharge member 13 is coupled to a motor 17 and can be rotated at an adjustable, variable speed, controlled by a motor control of the motor 17. During the discharge of the material, a change in the weight of a system of the dosing device 1 weighed by a load cell 19 is used to control the speed of the discharge member 13.

The dosing device 1 must be suitably configured for the bulk material 3 to be dosed. Therefore, it may be of particular interest, for example, to obtain information about the bulk material before a first dosing process in order to prepare the dosing device 1 appropriately. For this purpose, a method according to the first aspect of the invention, with which specific information about the bulk material can be determined, can be advantageously used.

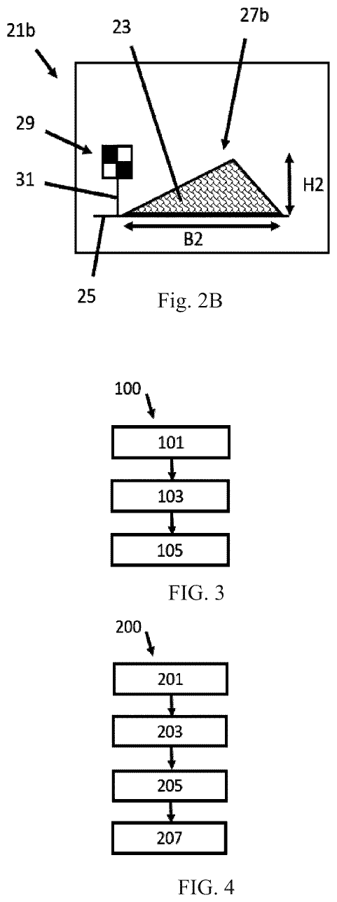

FIG. 2a shows a first image capture 21a of a sample 23 of a bulk material (which is to be dosed, for example, with the dosing device 1), in which the sample 23 is in a first sample configuration. To set the first sample configuration, the bulk material sample 23 was piled up from a defined height (for example, 40 cm) onto a base 25.

FIG. 2b shows a second image capture 21b of the bulk material sample 23, in which the sample 23 is in a second sample configuration. The bulk material sample 23 was transferred from the first to the second sample configuration by piling the bulk material sample 23 again from a defined different height (for example, 80 cm) onto the base 25.

Both image captures are taken from the side with an identical perspective. The sample configurations shown are two differently formed heaps 27a, 27b of the same bulk material sample 23. Due to properties, in particular material properties, of the bulk material of sample 23, the two differently formed heaps 27a, 27b with different heights H1 and H2 and different widths B1 and B2 are the result of the two different discharge heights, which are illustrated in the two image captures by labeled double-headed arrows.

In both image captures 21a, 21b a reference object 29 can also be seen. The reference object 29 is plate-shaped and is fastened to a mounting 31 in such a way that the main side of the reference object 29 is captured from the front in the image captures 21a, 21b. The dimensions of reference object 29 and the checkerboard pattern on reference object 29 are known. Thus, the reference object 29 can be used to determine a distance, for example a dimension of a structure of the bulk material, in the respective image capture 21a, 21b.

FIG. 3 shows a flowchart 100 of a method according to the first aspect of the invention in a first embodiment.

In 101, the first image capture 21a is obtained, which is the image capture 21a of the sample 23 of the bulk material to be dosed with the dosing device 1 in a first sample configuration. For this purpose, the data of the image capture 21a is received, for example, via a data line or retrieved from a memory.

In 103, based on these data of the first image capture 21a, a specific piece of information on the bulk material of the sample 23 is determined. For this purpose, the image data is processed using a processing module. The processing module is actually a machine learning (ML) model that has learned specific pieces of information about bulk materials during training based on numerous image captures of different bulk materials with an associated specific piece of information. (The image captures used for training each show a sample of the bulk material in a sample configuration as described in FIG. 2a, including the correspondingly placed reference object). The obtained image data is therefore fed to the processing module and thus to the ML model and the ML model is calculated on this image data. The ML model then produces output data that represents the specific piece of information about the bulk material.

In 105, the determined specific piece of information is output to a user on a user interface, such as a screen, and/or stored in a database.

This allows the specific piece of information about the bulk material to be determined based on the data from the first image capture 21a.

FIG. 4 shows a flowchart 200 of a method according to the first aspect of the invention in a second embodiment.

In 201, the first image capture 21a is obtained, which is the image capture 21a of the sample 23 of the bulk material to be dosed with the dosing device 1 in a first sample configuration. For this purpose, the data of the image capture 21a is received, for example, via a data line or retrieved from a memory.

In 203, the second image capture 21b is obtained, which is the image capture 21b of the sample 23 of the bulk material to be dosed with the dosing device in a second sample configuration. For this purpose, the data of the image captures 21b is received, for example, via a data line or retrieved from a memory.

In 205, the specific piece of information on the bulk material of sample 23 is determined based on the data of the first and second image captures 21a, 21b. For this purpose, the image data is processed using a processing module. The processing module is, strictly speaking, a machine learning (ML) model that has learned specific pieces of information about bulk materials during training based on numerous pairs of first and second image captures of different bulk materials (wherein the respective image captures of the respective sample of the bulk material are in the first and second sample configurations described above) with an associated specific piece of information. (The image captures used for training also show the correspondingly placed reference object 29). The obtained image data is therefore fed to the processing module and thus to the ML model and the ML model is calculated on this image data. The ML model then produces output data that represents the specific piece of information about the bulk material.

In 207, the determined specific piece of information is output to a user on a user interface, such as a screen, and/or stored in a database.

This allows the specific piece of information about the bulk material to be determined based on the data from the first and second image captures 21a, 21b.

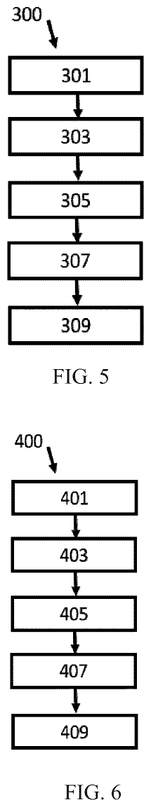

FIG. 5 shows a flowchart 300 of a method according to the first aspect of the invention in a third embodiment.

In 301, the first image capture 21a is obtained, which is again the image capture 21a of the sample 23 of the bulk material to be dosed with the dosing device 1 in a first sample configuration. For this purpose, the data of the image capture 21a is received, for example, via a data line or retrieved from a memory.

In 303 the image data is processed with a first evaluation module. The first evaluation module is actually a machine learning model (ML model) that has learned bulk material properties during training based on numerous image captures of different bulk materials with assigned properties. (The image captures used for training each show a sample of the bulk material in a sample configuration as described in FIG. 2a, including the correspondingly placed reference object 29). The obtained image data is therefore fed to the first evaluation module and thus to the ML model and the ML model is calculated on this image data. This results in output data at the output of the ML model, which represents a first property of the bulk material (i.e., a first piece of bulk material information). This is a material property of the bulk material.

In 305, a volume of data representing a second property of the bulk material (i.e., a second piece of bulk material information) is obtained via a user input. This is another material property of the bulk material.

In 307, the first property and the second property are processed by a processing module to determine the specific piece of information about the bulk material of the sample. The processing module is actually a machine learning (ML) model that has learned specific pieces of information about bulk materials during training based on numerous different combinations of the first property and the second property with an associated specific piece of bulk material information. The data (i.e. first property and second property) is therefore fed to the processing module and thus to the ML model and the ML model is calculated on this data. The ML model then produces output data that represents the specific piece of information about the bulk material. Additional data can also be provided as input data to the ML model, although this is not necessary in this case.

In 309, the determined specific piece of information is output to a user on a user interface, such as a screen, and/or stored in a database.

For example, the second property is a material property of the bulk material that was not determined from the image capture or possibly cannot be determined at all.

This allows the specific piece of information about the bulk material to be determined based on the data from the first image capture 21a and the volume of data In this case, the data of the first image capture 21a is not processed directly with the volume of data, but the first bulk material property determined on the basis of the data of the first image capture 21a is then processed together with the second bulk material property by feeding this data to the ML model of the processing module as input data.

In each of the embodiments of the method according to the first aspect of the invention described above, the determined specific piece of information can, for example, be a result of a classification and/or an identifier of the bulk material. For this purpose, an ML model can be provided in the processing module, which processes at least the respective input data with the ML model and provides the classification result and/or the identifier as output data. Determining the classification and/or determining the identifier then each represents at least part of determining the specific piece of information. Classification can advantageously be carried out with regard to the bulk material type and/or a (particularly average) particle size of the bulk material. It goes without saying that in the previous explanations the first bulk material property represents a first piece of bulk material information and the second bulk material property represents a second piece of bulk material information.

It should be noted that through the reference object 29, the ML model can also inherently learn and exploit a relationship between bulk material parts and the reference object, which can lead to better specific pieces of information. However, in alternative embodiments, it is possible that no reference object is placed in the image captures (both those obtained in the method and those used to train the respective ML model).

FIG. 6 shows a flowchart 400 of a method according to the second aspect of the invention. The procedure can be used to generate a data record with information about a bulk material. This data record can, for example, be provided as a data record in a method according to the first aspect of the invention. This also makes it possible to build a knowledge database with information on bulk materials. The information can, for example, concern the material properties of the bulk material.

In 401, a screen output on a touch screen is offered to a user.

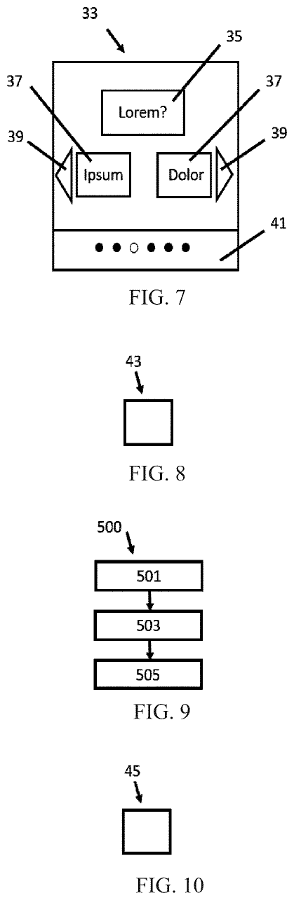

FIG. 7 shows an example screen output 33. In an area 35 of the screen output 33, a question (“Lorem?”) is displayed regarding a piece of information about a given bulk material. In areas 37, two possible answers to the question (“Ipsum” and “Dolor”) are displayed. In addition, two symbols 39 are shown in the screen output 33. These symbols 39 instruct the user, by interacting with the screen output 33, to move the screen output 33 either to the left or to the right by performing a corresponding swipe gesture on the touch-sensitive screen by the user. This depends on which of the two answers the user considers to be correct. Symbols 39 can be used to make the user's interaction with the screen output safer and more reliable. This also makes it possible to generate the data record more reliably. As indicated by the six circular areas in a lower area 41 of the screen output 33, the screen output 33 in FIG. 7 is the third of a total of six screen outputs that are offered to the user in succession for different pieces of bulk material information.

In 403 (see FIG. 6), an interaction of the user with the screen output 33 in the form of a swipe gesture is detected.

In 405, depending on whether the interaction is detected as a swipe gesture to the left or as a swipe gesture to the right, a characteristic value is generated for the requested information of the bulk material, for example either “0” (if the swipe gesture is to the left, i.e. the question “Lorem?” is answered with “Ipsum”) or “1” (if a swipe gesture is to the right, i.e. the question “Lorem?” is answered with “Dolor”).

By offering six such screen outputs with six different pieces of information about the bulk material (i.e., with different questions and answer options) and detecting a user interaction with the respective screen output, a characteristic value for this information is generated in 407, for example, “110011”, where each digit is the characteristic value of the individual screen outputs generated in 405. The characteristic value is then available as a generated data record.

In 409 the data record is saved in a database. In this database, a knowledge database with pieces of information on bulk materials can be built up by saving the generated data record with an assignment to the bulk material, which is optionally also the case here.

FIG. 8 shows a database 43 according to the third aspect of the invention, which is designed to store data sets from a method according to the second aspect of the invention. For example, in the method according to the second aspect of the invention described above with reference to the flowchart 400 of FIG. 6, the database mentioned in 407 may be the database 43.

The data within the database is also particularly advantageous for use alternatively or additionally as training data for ML models in methods according to the first aspect of the invention.

FIG. 9 shows a flowchart 500 of a method according to the fourth aspect of the invention. This method can be used to obtain specific information about a bulk material.

In 501, a first image capture of a sample of the bulk material in a first sample configuration is captured with a camera (this is, for example, the first image capture 21a from FIG. 2a) and/or a second image capture of the sample of the bulk material in a second sample configuration is captured with the camera (this is, for example, the second image capture 21b from FIG. 2b). The reference object 29 in each case can also be provided accordingly in the image capture.

In 503, the first image capture or the two image captures (in particular their image data) are provided in a method according to the first aspect of the invention and are received there as the first image capture and/or the second image capture. For example, this method could be explained as described in relation to FIGS. 3 to 5.

In 505, a specific piece information about the bulk material is obtained.

With the help of the specific piece of information, the dosing device 1 can be easily adjusted to suit the bulk material to be dosed. The method to which the image data is provided can advantageously be executed on a cloud server.

FIG. 10 shows a schematic depiction of a data processing device 45 according to the fifth aspect of the invention.

The data processing device 45 comprises means configured to carry out a method according to the first and/or second aspect of the invention.

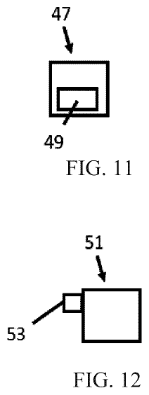

FIG. 11 shows a schematic depiction of a dosing device 47 according to the sixth aspect of the invention.

The dosing device 47 may be the dosing device of FIG. 1 with a data processing device 49 according to the fifth aspect of the invention, such as the device 43 as described with reference to FIG. 8.

FIG. 12 shows a schematic depiction of a data processing device 51 according to the seventh aspect of the invention.

The data processing device 51 is a smartphone with a camera 53. The device 51 offers the operating personnel of the dosing device 1 a flexible possibility of determining information about a bulk material 3 to be dosed, for example, before it is filled into the storage container 5.

For this purpose, the data processing device 51 comprises means which are designed to provide images taken with the camera 53 (for example the image captures 21a and/or 21b) in a method according to the first aspect of the invention in such a manner that they are obtained there as a first image capture and/or a second image capture.

The features disclosed in the description above, in the drawings and in the claims can be essential to the invention in its various embodiments, both individually and in any combination.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for determining a specific piece of information about a bulk material, the method comprising:
obtaining a first image capture from a sample of the bulk material;
determining, via a first evaluation module, a first piece of bulk material information based on the data of the first image capture; and
obtaining a second piece of bulk material information through a user input or via a human-machine interface, the second piece bulk material information being a haptic property of the bulk material,
wherein the specific piece of information about the bulk material is determined via a processing module based on the data of the first and second piece of bulk material information.

2. The method according to claim 1, wherein the method comprises obtaining a second image capture of the sample of the bulk material, and wherein the specific piece of information about the bulk material is determined based on the data of the first and second image captures by means of the processing module.

3. The method according to claim 1, wherein the method further comprises: evaluating and/or analyzing the data of the first and/or second image capture using methods of digital image analysis in the field of machine learning, in each case in order to determine the first piece of information, the second piece of information and/or the one specific piece of information.

4. The method according to claim 1, wherein determining the one specific piece of information comprises determining a classification with respect to the type of bulk material, an average particle size of the bulk material and/or a particle shape, and/or an identifier of the bulk material, and wherein a result of the classification and/or the identifier is the specific piece of information.

5. The method according to claim 1, wherein a control signal representing the determined specific piece of information is generated and supplied to an entity and/or output to a user on a human-machine interface and/or wherein a dosing device is influenced, configured and/or controlled based on the determined specific piece of information.

6. The method according to claim 1, wherein
(i) the first piece of bulk material information is at least one of the following properties of the bulk material or a measure thereof:
a grain shape,
a grain size, a particle size,
an angle of repose, an angle of discharge,
a physical property, and/or
a chemical property, a moisture content, a material type, a density, a flow behavior, a tendency to bridge, a tendency to shoot when fluidized, a clumping content, an electrostatic chargeability, a chemical instability, a temperature sensitivity, suspended in air, a tendency to segregate, consisting of components, a free flowability, a tendency to agglomerate, an abrasiveness, a corrosiveness, a mechanical sensitivity, a fragility, an explosiveness, a flammability, a dustiness, a moisture, an adhesion, a consistency, a hygroscopic behavior, a temperature, a tendency to fluidize, a tendency to harden, a radioactivity, a toxicity, a thixotropic behavior, a tendency to spoil, a tendency to soften, a static electricity, a presence of oils and fats, a flakiness and/or a stickiness; and/or
(ii) the second piece of bulk material information is at least one of the following properties of the bulk material or a measure thereof:
a grain shape, a grain size, a particle size, an angle of repose, an angle of discharge, a physical property, a chemical property, a moisture content, a material type, a density, a flow behavior, a tendency to bridge, a tendency to shoot when fluidized, a clumping content, an electrostatic chargeability, a chemical instability, a temperature sensitivity, suspended in air, a tendency to segregate, consisting of components, a free flowability, a tendency to agglomerate, an abrasiveness, a corrosiveness, a mechanical sensitivity, a fragility, an explosiveness, a flammability, a dustiness, a moisture, an adhesion, a consistency, a hygroscopic behavior, a temperature, a tendency to fluidize, a tendency to harden, a radioactivity, a toxicity, a thixotropic behavior, a tendency to spoil, a tendency to soften, a static electricity, a presence of oils and fats, a flakiness, and/or a stickiness.

7. The method according to claim 1, wherein the method further comprises: offering to a user a screen output on a user interface, detecting an interaction of the user with the screen output on the user interface in response to the offering of the screen output, and generating, based on the detected interaction of the user, a characteristic value storable in a database for the one specific piece of information of the bulk material as a data record.

8. The method according to claim 7, wherein a plurality of screen outputs are offered to the user on the user interface and for each screen output an interaction of the user with the screen output on the user interface in response to the offering of the respective screen output is respectively determined and based on the determined interactions of the user one or more than one characteristic value storable in a database for two or more than two pieces of information about the bulk material, in particular for two or more than two properties of the bulk material, is generated as a data record.

9. The method according to claim 7, wherein several such data records are generated by interactions between several users, and wherein preferably the several data records are transferred into a common data record in which the specific piece of information on the bulk material is constructed from the information of the individual data records, and/or wherein the data record or sets is or are in each case associated with an assignment to the bulk material and/or is or are stored in a database, in particular for the purpose of building, supplementing and/or updating a knowledge database on bulk material information.

10. A data processing device, in particular a smartphone, comprising: a camera and further components to provide data in the method according to claim 1 such that images recorded by the camera are received there as the first image capture and/or as the second image capture and thus as the first piece of bulk material information, and haptic properties of the bulk material entered via a user input are received as the second piece of bulk material information.
